(19) United States
(12) Patent Application Publication
(10) Pub. No.: US 2001/0012354 A1
(43) Pub. Date: Aug. 9, 2001

(54) SUBSCRIBER DATABASE ON AN INTELLEGENT PERIPHERAL IN AN ADVANCED INTELLIGENT NETWORK (AIN)

(75) Inventor: JONATHAN J. SILVER, BOCA RATON, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION

(21) Appl. No.: 09/079,664

(22) Filed: May 14, 1998

(51) Int. Cl. H04M 7/00; H04M 1/64

(52) U.S. Cl. 379/221.08; 379/88.25

(57) ABSTRACT

An Automated Intelligent Network (AIN) telephone system comprising at least one central office switching system is disclosed. An intelligent peripheral subsystem for coupling with the central office switching system comprising: auxiliary call means for providing at least one auxiliary call processing capability via a call connection channel; accessing means for directly accessing a database storing subscriber-specific data; and subscriber service means for providing subscriber services using the accessing means for accessing subscriber-specific data.

### CROSS-REFERENCE TO RELATED APPLICATIONS

Not applicable.

1. Field of the Invention

The invention disclosed broadly relates to the field of telephony services using an Intelligent Peripheral (IP) in an Advanced Intelligent Network (AIN), and more particularly relates to the storage of subscriber data in a database coupled to an IP.

2. Description of the Related Art

Over the past few years, the number of new services and features offered over Advanced Intelligent Networks (AINs) has grown. The AIN allows telephone companies to decentralize intelligence away from monolithic switches onto nodes throughout the network. This decentralization increases flexibility, enabling new automation, and making new services possible. The AIN system can be broadly divided into two types of segments, a call service segment and a call setup/routing segment. Call service segments contain intelligent subsystems for providing subscriber services such as call waiting, call forwarding, voice announcements, voice response, and keyboard response. These intelligent subsystems, called “Intelligent Peripherals” (IPs), are configured for specific regional calling services. The other segment, the call setup/routing segments, contains IPs for controlling switched traffic including service transfer points (STPs) communicating to service control points (SCPs) for directing and controlling call routing. Typically the SCP routes calls and can govern the subscriber services provided on the IP. For example, a voice mail application may be activated by the SCP upon receiving an incoming call for a subscriber enrolled in a phone mail service.

Along with the quantity of different telephony services being offered, the complexity of many of the newer services has also increased. The increase in provider service offerings is typically accompanied by the need for more subscriber-specific data. One example of a new service requiring subscriber-specific data is the telephony service called “find me”. The “find me” service enables subscribers to provide a single telephone number for contact and have the “find me” service automatically dial and forward incoming calls to other telephone numbers according to the subscriber's selected preferences. It is common for mobile service personnel such as health care providers to distribute a single telephone number for a point of contact 24 hours a day. The “find me” service automatically dials each telephone number in an order list until the subscriber is reached or until an option such a phone mail is selected. The order list may change depending on the time of day or the day of the week. The subscriber may also update the ordered list as needs change. This order list or more generally, the subscriber-specific data, is stored on a database coupled to the SCP in the call setup/routing segment of the AIN system.

There are many other telephony services being made available on AIN systems that require subscriber-specific data. Other telephony services include “call screening” that allows a subscriber to process incoming telephone calls differently depending on a list of “preferred” telephone numbers. Returning to the health care provider example, a doctor may only accept calls from emergency services at certain times of day and have the rest of the calls be handled by voice mail. For this example, the doctor's “preferred” list would include the originating telephone of the emergency services. The list of “preferred” originating calls is customized to each subscriber. Another example of a subscriber service that requires subscriber-specific data is the “call director” service where the subscriber can provide a menu hierarchy to retrieve information such as departmental listings or fax back services. The menu hierarchy and response are customized for each subscriber. This customized subscriber data is stored on a database coupled to the SCP.

As described above, telephony services are provided by the service segment and more particularly by the IP. The SCP service logic along with the subscriber database governs the IP system to provide the appropriate service. The separation of the subscriber data coupled to an SCP increases the network utilization between the IP and SCP. This increase in network utilization is undesirable because it reduces the overall system availability of the AIN system. In addition, the network protocol (1129+) between the SCP and IP is very limited. The use of this limited protocol along with the transfer of subscriber-specific information from the SCP to the IP is inefficient. The database coupled to the SCP is proprietary and offers limited datatypes. The combination of limited datatypes combined with limited protocols makes the transfer of subscriber-specific data even more inefficient. And for some more advance subscriber services, such as fax-back service, the storage of subscriber-specific data Many of the databases coupled to SCP are proprietary. The use of proprietary database systems that are coupled to SCP systems can be very limiting. One limitation is the ability of service developers for services running on an IP to control the organization of the database. Another limitation is the availability of tools for management and a maintenance of proprietary database systems. Still, another limitation is the ability to add additional subscriber services without the need to add additional back-end processing in the call routing/setup process segment. Accordingly, a need exists to provide tools to manage databases for subscriber services requiring customized subscriber data.

### SUMMARY OF THE INVENTION

Briefly in accordance with the present invention, an Automated Intelligent Network (AIN) telephone system comprising at least one central office switching system is disclosed. An intelligent peripheral subsystem for coupling with the central office switching system comprising: auxiliary call means for providing at least one auxiliary call processing capability via a call connection channel; accessing means for directly accessing a database storing subscriber-specific data; and subscriber service means for providing subscriber services using the accessing means for accessing subscriber-specific data.

### BRIEF DESCRIPTION OF THE DRAWING(S)

FIG. 1 is a functional block diagram of a telephone network conforming to AIN architecture.

FIG. 2 is a functional block diagram of a telephone network conforming to AIN architecture according to the present invention.

FIG. 3 is a block diagram of the hardware architecture of an intelligent peripheral (IP) system for the network of FIG. 2.

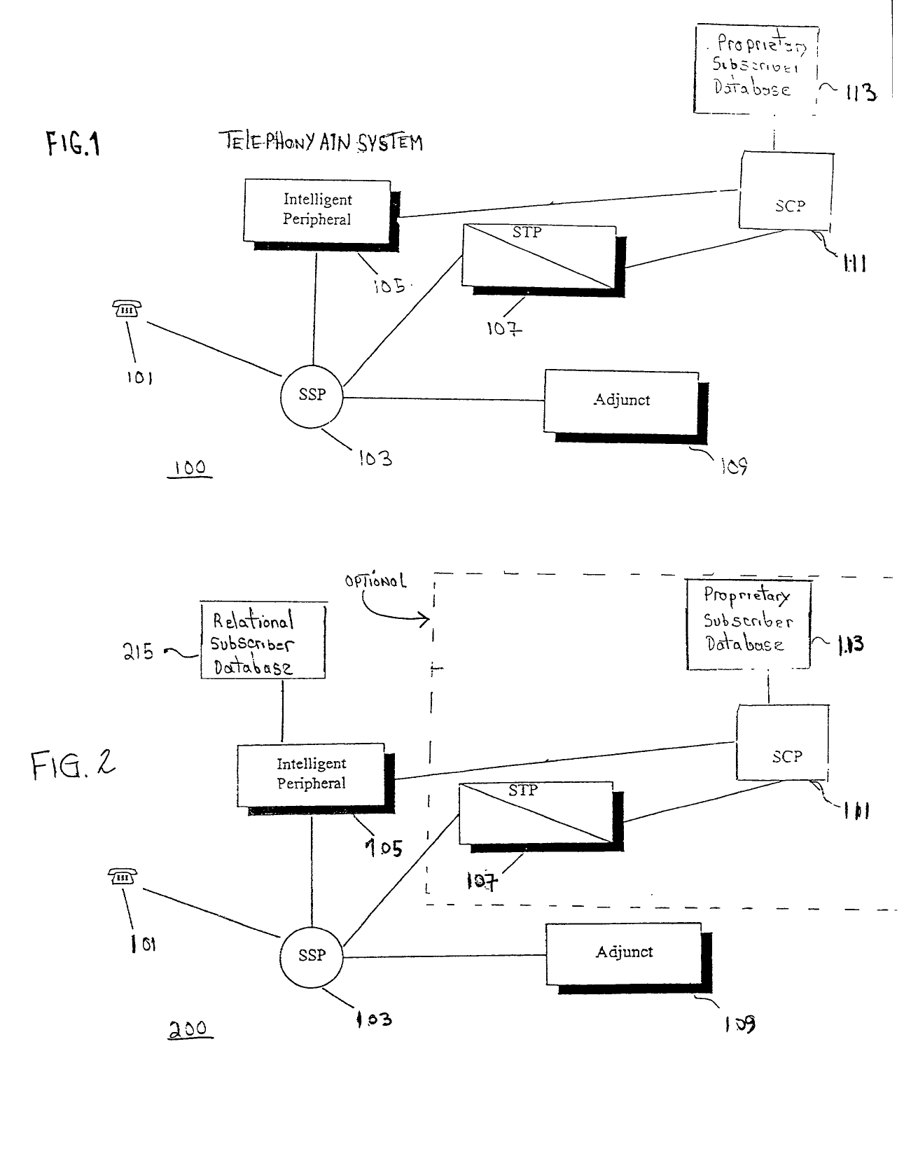

FIG. 1 is a functional block diagram of a prior art telephone network conforming to AIN architecture.

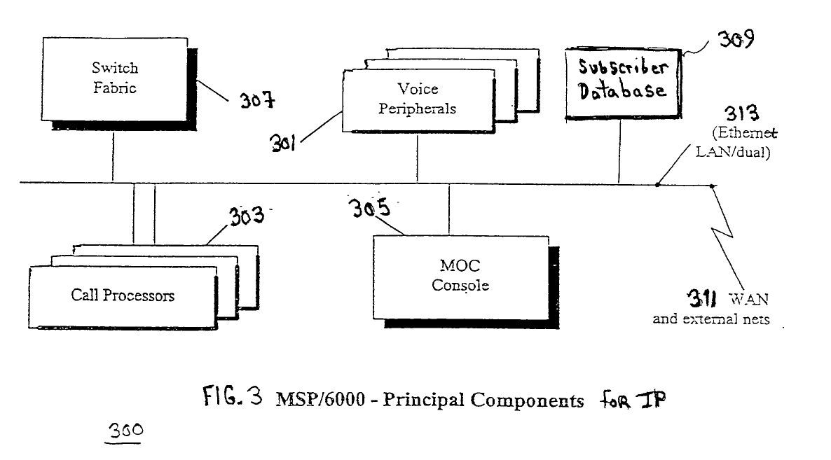

FIG. 2 is a functional block diagram of a telephone network conforming to AIN architecture according to the present invention.

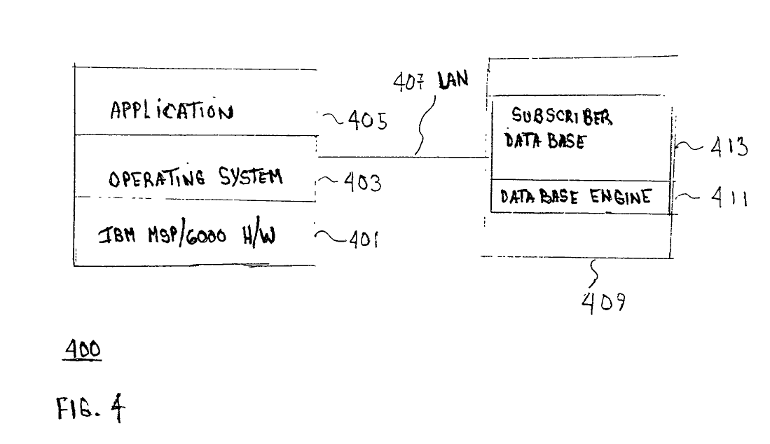

FIG. 3 is a block diagram of the hardware architecture of an intelligent peripheral (IP) system for the network of FIG. 2.

FIG. 4 is a block diagram of the hardware architecture of an intelligent peripheral (IP) system of FIG. 3, illustrating the use of a subscriber database according to the present invention.

### DESCRIPTION OF A PREFERRED EMBODIMENT

FIG. 1 illustrates a prior art network conforming to public switched telephone network (“PSTN”) architectures for an advanced intelligent network (“AIN”) 100. Further information about AIN architecture can be obtained by referring to one or more of the following published documents, whose teachings are incorporated herein by reference.

Bellcore, GR-2802-CORE, Advanced Intelligent Network (AIN) 0.X Issue 1, Generic Requirements, Issue 2, December 1993.

Bellcore, GR-1129-CORE, Advanced Intelligent Network (AIN) 0.2 switch Intelligent Peripheral Interface (IPI) Generic Requirements, ILC 1E, November 1994.

ISC-IP Interface Specification, Bellcore, SR-3511.

The AIN system 100 is associated with a regional node of the PSTN. A telephone unit 101, available to a “local” PSTN user, links to the regional node through a signal switch points (SSP) complex 103. The SSP 103 connects to an intelligent peripheral (IP) system 105, a hierarchical network of signaling transfer points (STPs) 104, and an adjunct system 109.

The IP 105 provides switched connections for telephone calls passing through the respective regional node (e.g., between local and trunk lines traversing the node), and controls service applications associated with respective calls (conferencing, voice announcements, speech recognition applications, call forwarding, and more). The SSP 103 supports communications between telephones such as the unit 101 and the IP 105 using ISDN (Integrated Services Digital Network) connections.

The SSP 103 communicates through the STPs with a service control point (SCP) 111, using a known signaling system and SS7 packet-switched message format. The IP 105 and the SCP 111 coordinate service logic functions (e.g. functions required to play voice announcements) using a known “1129+” signaling protocol. Subscriber-specific data is stored in a proprietary subscriber database 113 coupled to the SCP 111.

Call connection channels between local telephones such as the telephone 101 and other local telephones are formed by operations of the IP 105 and the SSP 103. Connections between local telephone 101 and remote telephones associated with remote SSPs and IPs are formed by transmission of call setup messages between the SSP 103 and the remote SSPs via the STP 104 (and other STPs if appropriate) as well as the SCP 111 (and remote SCPs if appropriate). Upon determining that a path exists for a required remote call connection, the SSP 103 and the other SSPs cooperate with respective IPs to establish the connection.

Message communications, between SSP's such as the SSP 103 and both respective IPs such as the IP 105 and associated SCPs such as the SCP 111, are required to set up call connections and administer telephone user services associated with respective calls. Such message communications are conducted through a common channel signaling (CCS) network formed between the SSPs, the STPs, and the SCPs using the aforementioned SS7 packet switched signaling protocol. The SS7 protocol is used as a network transport layer to facilitate message communication within the CCS network. A regional CCS network, encompassing a region containing the local switching office nearest to the telephone 101 and other switching offices, contains a hierarchy of STPs associated with a hierarchy of SCPs. Each SSP, at local levels nearest to individual user telephones such as 101, connects to two SSPs associated with the respective level. This redundancy is useful to produce high reliability.

Message communications between IPs such as the 105 and SCPs such as the SCP 111 are conducted in the previously mentioned “1129+” signaling protocol. That protocol enables service logic running on the SCPs to coordinate actions with service logic running on the IPs during delivery of telephone services to telephones such as the telephone 101.

Operations of elements 103-111 enable an authorized user of the telephone 101 (e.g. the owner of the telephone or an authorized representative of the owner) to administer services to which the owner of the telephone has subscribed (both conventional services, such as call waiting and call forwarding, and new services yet to be defined) without required assistance of operators or other human representatives of the telephone company that interfaces to the telephone.

The SSPs are program-controlled telephone switching systems (either access tandem switches or end officers) without local networks connecting to user telephones in a local sub-region. They form local interfaces to the aforementioned CCS network.

The SCPs are stand-alone network systems which, in existing intelligent telephony control networks, have been primary focal points for administration of services provided to PSTN users. An SCP can contain service logic and online, real-time database systems. An SCP provides call processing information and instructions in response to queries received through the CCS network.

The SCPs support multiple applications, each containing logic defining the handling of individuals' calls. After determining actions to be performed in response to a specific query, the SCP sends instructions for handling the respective call back to the SSP that initiated the inquiry. Different services/applications may be offered at different SCPs.

Adjuncts 109 are also stand-alone network systems. They are functionally equivalent to SCPs, but each communicates directly with only one locally associated SSP (whereas SCPs can communicate with multiple SSPs, both within and external to a local region or sub-region). In operation, such adjunct networks enable the development and delivery of telephony services which are not totally reliant on SSPs and SCPs for implementation.

The AIN system can broadly be divided into two types of segments, a call service segment and a call setup/routing segment. The call service segment includes the IP 103 and the SSP 103. The call setup/routing segment provides traffic switching and includes the STP 107 and the SCP 111. The principal difference between the SCP 111 and the IP 103 is the SCP 111 does not support auxiliary caller service interaction such as voice announcements, voice response, DTMF (dual tone multi-frequency signal generated by touch tone telephones), call waiting, and call forwarding. For example, a caller to a subscriber “find me” service would be routed through the call setup/routing segment of the SCP 111 through the STP 107. The SCP 111 retrieves the subscriber service data from the proprietary subscriber database 113 that is keyed to the telephone number dialed the specific incoming call. If the telephone number subscriber has an active “find me” ordered list, a message is sent from SCP via 1129+ protocol to the IP 103 to play the appropriate outgoing message e.g. “Looking for Mr. Jones” and command the IP 103 to dial the first number as specified in the subscriber's me” list located on the proprietary subscriber database 113. The SCP 111 continues retrieving stored subscriber information from the proprietary subscriber database 113 and sending 1129+ commands to the IP 103 until the process is complete.

It is important to understand that the present invention is not limited to AIN network implementations currently in use in North America and described herein. Many other telephony Intelligent Network implementations are used throughout the world. These other Intelligent Network standards may include other signaling standards and network protocols. Therefore it should be understood that the other Intelligent Network implementations are contemplated and come within the true scope and spirit of this present invention.

FIG. 2 is a functional block diagram 200 of a telephone network conforming to AIN architecture according to the present invention. Notice that the components are the same as the AIN system FIG. 1 except here a subscriber relational database 215 is directly coupled to the IP as contrasted with the AIN system shown in FIG. 1 where the IP 105 was coupled to proprietary subscriber database 113 via SCP 111. The technique of directly coupling a database is well known. Typically any computer communications interface can be used. In another embodiment, the relational database 215 is running on the IP system itself, without the need of directly coupled external communications. All the components of the call setup/routing segment 207, 211 and 213 are optional (as denoted by the broken line).

FIG. 3 shows the principal components 300 of the IP system 105 of FIG. 1. IP system 105 is preferably based upon an IBM MSP/6000 system. Standard elements of an MSP/6000 system include a “switch fabric” complex 307, voice peripherals 301, call processors 303, a maintenance and operations console (MOC) processor 305, all connected via communications links Ethernet/LAN 313 and external WAN 311. A subscriber database 309 for subscriber data is attached to Ethernet/LAN 313. Critical components including voice peripheral components of the call setup/routing segment 207, 211 and 213 are optional (as denoted by the broken line).

FIG. 3 shows the principal components 300 of the IP system 105 of FIG. 1. IP system 105 is based upon an IBM MSP/6000 system. Standard elements of an MSP/6000 system include a “switch fabric” complex 307, voice peripherals 301, call processors 303, a maintenance and operations console (MOC) processor 303 are all attached via communications links Ethernet/LAN 313 and external WAN 311. A subscriber database 309 for subscriber data is attached to Ethernet/LAN 313. Critical components including voice peripheral processors 301 and call processors 303 are configured redundantly to ensure continuous availability in case of any component failure. Further information on the IBM MSP/6000 system can be found in the patent application entitled “Multi-processor systems used as an AIN system” application Ser. No. 08/792,018 by Deborah L. Acker and Thomas E. Creamer and assigned to International Business Machines (IBM) and is incorporated herein by reference. Customize telephony services running on MSP/6000 include detailed billing, call forwarding, call waiting, voice announcements, voice response, keyboard response, debit card call, detailed billing, peak/off peak charges and more.

FIG. 4 is a block diagram 400 of an IP system 300 of FIG. 3 coupled via LAN 407 to a database server 409 containing a subscriber database 413 and corresponding database engine 411. The IP system 400 preferably comprises an IBM MSP/6000 computer hardware platform 401 with an operating system 402 such as AIX with database APIs such as IBM DB/2 or Oracle SQL for accessing a subscriber database server 409. An application 405 written in any of a variety of programming languages such as C/C++, Assembler, JAVA, or SmallTalk is used to create a desired application. The database engine 413 can be a relational database such as IBM DB/2 or Oracle or equivalent. The organization of the subscriber database 413 is directed by the subscriber service provider. This provides the service provider with great flexibility in the structure and arrangement of the subscriber data. The subscriber database 413 is a collection of subscriber specific data that is dependent on the type of subscriber service being offered by the service provider. Typical subscriber data may include, find me lists, out going announcements, service plans, subscriber's telephone number and any other data necessary for a particular subscriber service. The use of a standard relational database allows for the use of a wide variety of database tools and maintenance options.

In the preferred embodiment, the database server 409 is a highly available cluster (HACMP) multi-processor machine. The HACMP consists of a plurality of machines each able to process database request in a concurrent manner. If one machine goes down, the other machine continues processing. In addition, facilities such as load balancing of the database requests and fail-over of database hardware are incorporated. The HACMP automatically re-routes database requests to active machines to provide a database server with little or no down time during hardware failures.

In another embodiment, the IP 400 includes a monitoring function in application 405 for monitoring key parameters of the database server 409. Key parameters including the amount of available hard disk storage, processor(s) utilization, database throughput, and database availability. When these monitored parameters exceed a preset bound, the monitoring function of application 405 makes adjustments to the operation of the database server 409 such as increasing the database storage size, or loading of the database resources. These adjustments by application 405, maintain the database server 409 in a desired operational range without the need for human intervention.

It is important to point out that the exact hardware and software configuration of database server 409 is not critical and the present invention will work with a variety of software and hardware platforms. In addition, the database tools are not limited to the operating system and hardware of IP 400. The database tools will work on a variety of platforms including Sun Solaris, Microsoft NT, HP Unix or even via the Internet.

In still another embodiment the ability to carry on non-call based periodic functions is incorporated in the database 413. Non-call functions can be initiated after a predetermine period of time or through the use of database triggers and equivalent techniques. Database triggers are industry standard database features that allow architects of databases to automatically notify other software applications that a pre-selected database record or range of database records is being modified. These software applications can perform any desirable task in response to a database update including the task of rejecting a request that a specific database entry be updated. For example, a service providers may wish to implement a PIN (Personal Identification Number) for a given subscriber service as a procedure to enhance security. The use of PINs to authorize access to subscriber specific data is known. Many service providers allow users to update their own PIN via an IVR (Interactive Voice Response) system or even the Internet. It is common for service providers to enforce a security policy that user PINs be a certain number of digits in length or that PINs comprise specific alpha-numeric characters. Through the use of triggers, a database developer can have any attempted changes to a PIN entry in a database trigger a previously designated external application. The application in this PIN example, could be a PIN authentication application, which is invoked when a change to the database record is requested. This PIN authentication application authorizes the change or rejects the requested change because the PIN does not conform to the desired security policy. The use of a trigger allows the separation of the database application from other software applications. This makes database administration and maintenance easier because the external applications signaled by the database triggers can be separately maintained.

The use of database triggers gives service providers the ability to “trigger” a wide variety of AIN system events. The trigger can even notify two or more applications that a predefined database record is being altered. Typical external applications perform a variety of functions including inventorying and tracking the use of various services, deleting voice messages after the messages reach an expiration date, updating external database servers (not shown) for disaster recovery or off-line administration, issuing billing records to external billing processors (not shown), and resetting subscriber data such as out going announcements to system default messages.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. In an Automated Intelligent Network (AIN) telephone system comprising at least one central office switching system, an intelligent peripheral subsystem, for coupling with a central office switching system, comprising:
auxiliary call means for providing at least one auxiliary call processing capability via a call connection channel;
accessing means for directly accessing a database storing subscriber-specific data; and
subscriber service means for providing subscriber services using said accessing means for accessing subscriber-specific data.

2. The intelligent peripheral subsystem of claim 1 further comprising the database for storing subscriber-specific data.

3. The intelligent peripheral subsystem of claim 2 wherein said database is running on a HACMP (highly available cluster multi-processor) platform.

4. The intelligent peripheral subsystem of claim 3 wherein said service means further comprises:
parameters specific to said HACMP;
database parameters specific to said database; and
monitoring means for monitoring the performance of said database so as to selectively change database resources of said database according to said parameters of said HACMP.

5. The intelligent peripheral subsystem of claim 3 wherein said subscriber service means further comprises:
subscriber-service data stored in said database
periodic update parameters associated with said database; and
periodic update means for selectively updating said subscriber-specific data according to said parameters.

6. The intelligent peripheral subsystem of claim 5 wherein said parameters comprise non-call services.

7. The intelligent peripheral subsystem of claim 2 wherein said intelligent peripheral subsystem is an IBM MSP/6000 platform.

8. In an Automated Intelligent Network (AIN) telephone system comprising at least one central office switching system and an intelligent peripheral subsystem for coupling with a central office switching system, a method for providing subscriber services comprising the steps of:
providing at least one auxiliary call processing capability via a call connection channel;
directly accessing a database storing subscriber-specific data; and
providing subscriber services using said subscriber-specific data from said step of direcly accessing accessing a database.

9. The method for providing subscriber services of claim 8, wherein the step of directly accessing a database comprises accessing a database storing subscriber-specific data resident.

10. The method for providing subscriber services of claim 9 wherein said database is running on a HACMP (highly available cluster multi-processor) platform.

11. The method for providing subscriber services of claim 10 wherein said service means further comprises:
parameters specific to said HACMP;
database parameters specific to said database; and
monitoring means for monitoring the performance of said database so as to selectively change database resources of said database according to said parameters of said HACMP.

12. The method for providing subscriber services of claim 10 wherein said subscriber service means further comprises:
subscriber-service data stored in said database
periodic update parameters associated with said database; and
periodic update means for selectively updating said subscriber-specific data according to said parameters.

13. The method for providing subscriber services of claim 12 wherein said parameters comprise non-call services.

14. The method for providing subscriber services of claim 9 wherein said intelligent peripheral subsystem comprises an IBM MSP/6000 platform.
